(19) United States
(12) Patent Application Publication
(10) Pub. No.: US 2006/0266114 A1
(43) Pub. Date: Nov. 30, 2006

(54) Arrangement for precision balancing the rotor of a gas turbine engine

(76) Inventors: Sacha Pichel, Berlin (DE); Ingo Jahns, Berlin (DE); Moritz Wirth, Berlin (DE)

Correspondence Address: Timothy J. Klima;Harbin King & Klima, 500 Ninth Street SE, Washington, DC, 20003, US

(21) Appl. No.: 11/441,347

(22) Filed: May 26, 2006

(30) Foreign Application Priority Data
May 26, 2005 (DE) 10 2005 025 086.6

(51) Int. Cl. G01M 1/16

(52) U.S. Cl. 73/460

(57) ABSTRACT

For precision balancing of the rotor (3) that, in fully assembled condition of a gas turbine engine, is encompassed by an inner and an outer case, inserts (7) with a through hole (11) and a female threaded section are positioned at an even spacing in at least one circumferential groove (6) of the rotor disks (5) that receives the roots of the rotor blades (4). A temporarily installed guide tube (15) that runs through the openings (13, 14) connects to the through hole that in a certain rotor position is in line with the openings (13, 14) in the inner and outer cases (1, 2) for inserting and screwing in a balancing screw (16).

This application claims priority to German Patent Application DE 10 2005 025 086.6 filed May 26, 2005, the entirety of which is incorporated by reference herein.

### BACKGROUND OF THE INVENTION

This invention relates to an arrangement for precision balancing a rotor of a gas turbine engine while in its fully assembled state and encompassed by outer and inner cases.

The rotors of compressors and turbines of a gas turbine engine rotate at a very high speed. Improperly balanced rotors can cause bending of the shaft which may result in gap bridging and contact of the rotor with static parts. The running gaps thus developing result in efficiency loss. In addition, undesirable vibrations occur that cause early bearing wear or acute bearing damage. This can shorten the service life of the rotor components considerably. It is known that rotors are balanced by adding weights to, or removing material from, the rotating components.

The rotors of a gas turbine engine that rotate at a high speed are first balanced when the rotating components of the engine that have been manufactured in that material are removed from the individual drums. The rotor is then balanced a second time in its assembled state. After the engine has been fully assembled with its rotor being housed in inner and outer cases, only minor adjustments of the low-pressure shaft can be performed while precision balancing, i.e., removing residual imbalances of the high-pressure shaft that can only be accessed with difficulty when the gas turbine engine is assembled and the rotors are encompassed by the outer and inner cases, is virtually unfeasible or requires considerable effort. A residual imbalance of the high-pressure shaft can result in considerable vibration and the resulting damages.

U.S. Pat. No. 5,545,010 describes an arrangement for trim balancing a gas turbine engine in which the rotating components with the required counterbalances are accessed while being encompassed by an outer case. The apparatus includes a band attached to an outer surface at the inlet side of the compressor or integrally molded to it with threaded holes at an even spacing for screwing on or removing balancing weights. The band with the threaded holes or balancing weights is accessed through an opening provided in the wall of the air inlet duct of the compressor that is in line with the threaded holes. Such an arrangement has the disadvantage that the band has a relatively heavy weight and accessibility via the gas path is only provided to the first rotor stage on the compressor. The balancing weights are attached near the bearing in a section that is small in diameter. This does not allow for efficient rotor dynamics and requires accordingly great weights.

It is an object of this invention to provide an arrangement for precision balancing the rotor of a gas turbine engine in its fully assembled state while being encompassed by outer and inner cases, which arrangement has little weight of its own and allows efficient precision balancing of the rotor using small balancing weights only.

### BRIEF SUMMARY OF THE INVENTION

This problem is solved according to the invention by the arrangement comprising the characteristics described herein. The description below discloses further advantageous improvements of the invention.

The core element of the invention is that inserts with a through hole and a section with a female thread are arranged at an even spacing in a circumferential groove that holds blade roots of rear rotor disks of the compressor or turbine. The through hole of the respective insert has a certain position when it is in line with an opening each provided in the inner and outer cases of the rotor via which a guide tube is installed for inserting and screwing in a balancing screw and for guiding a tool to the through hole.

Thus, with little effort, it is possible to remove any residual imbalances when the engine is assembled, e.g., after final assembly or repairs, and thus to extend a service life of the engine. In addition, the balancing is performed in an optimum range in terms of rotor dynamics which means that it can be effected with little additional weight far out at the rotor disks and in a medium portion of the rotor. Existing engines can easily be retrofitted with the balancing system as existing circumferential grooves are utilized. The system only requires low costs and small weights as compared to other balancing systems.

In another embodiment of the invention, the insert is designed in such a way that the through hole is perpendicular to, or at an acute angle with, the rotor axis and that the openings in the inner and outer cases are placed vertically above the circumferential groove or at the respective offset from it. When the through hole is at an acute angle, an existing air bleeding slot in the inner case can be used as an opening.

In a further improvement of the invention, the inserts consist of a base part that matches the cross section of the groove and a threaded part adjusted to the base part for receiving the balancing screw.

The outer peripheral surface of the insert is encompassed by recesses of adjacent blade platforms. The balancing screw is self-locking to prevent its loosening during operation.

### BRIEF DESCRIPTION OF THE DRAWINGS

An embodiment of the invention is explained in greater detail below with reference to the figures. Wherein:

FIG. 1 shows a detailed cross section of a rear rotor stage of the compressor of a gas turbine engine encompassed by an inner and outer case while a balancing weight is inserted;

FIG. 2 shows the same view as FIG. 1 but with the engine in operational condition after balancing is completed;

FIG. 3 shows an enlarged view of an insert inserted into the circumferential groove of a rotor disk of the compressor;

FIG. 4 shows a longitudinal section with an insert placed in the circumferential groove between two rotor blades, and

FIG. 5 shows a sectional view of the other rotor stage into which the balancing weight is inserted via an existing slot in the inner case into a slanted insert.

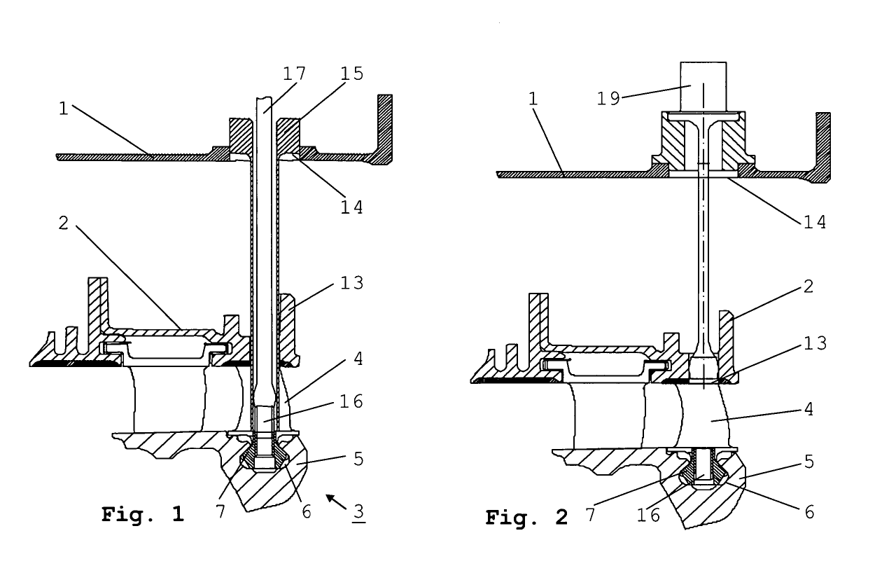

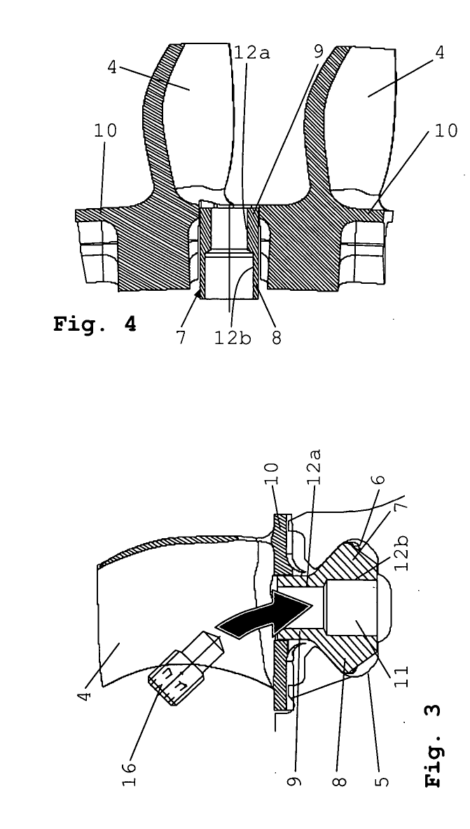

### DETAILED DESCRIPTION OF THE INVENTION

In the engine shown in the figures, reference symbol 1 denotes the outer case, 2 the inner case and 3 the rotor, or more precisely, a rear rotor stage of the compressor. Rotor blades 4 are inserted into a circumferential groove 6 provided on the outer surface of a rotor disk 5 of this rear rotor stage. The circumferential groove 6 houses multiple inserts 7 placed at an even spacing around its perimeter. The insert 7 includes a base part 8 that matches the cross-sectional shape of the circumferential groove 6, a threaded part 9 encompassed by opposite recesses of two adjacent platforms 10 of adjacent rotor blades 4, and a hole 11 with a female threaded section 12a. Other components of the precision-balancing arrangement are a first opening 13 in the inner case 2 and a second opening 14 in the outer case 1 that is vertically aligned with the first opening 13. In a certain rotational position of the rotor 3, the holes 11 are in line with the first and second openings 13, 14 so that a guide tube 15 can be slid through the openings and placed adjacent and aligned with the hole 11 of a respective insert 7.

The guide tube 15 is fixed, either by form-fitting or with fastening screws, in the opening 14 of the outer case. Now the guide tube 15 can be used to guide a balancing screw 16 for precision balancing the fully assembled rotor 3 that is encompassed by the inner and outer cases 1, 2 to the respective hole 11 in the insert 7 and to screw it into this insert 7 using a tool 17 inserted through the guide tube 15. Various balancing screws 16 can be positioned at various spots around the circumference of the rotor to improve the balance of the rotor 3. The balancing screws 16 can be of the same size and weight or can differ as to weight or size, as conditions warrant. The effect of the balancing screw 16 on the balance of the rotor 3 can be adjusted by how far the balancing screw 16 is screwed into the threaded section 12a. Farther in decreases the moment of the balancing screw 16 and farther out increases the moment of the balancing screw 16. The balancing screw 16 can use mechanical or chemical thread locking components to retain the balancing screw 16 in the threaded section 12a and to prevent undesired back out of the balancing screw 16.

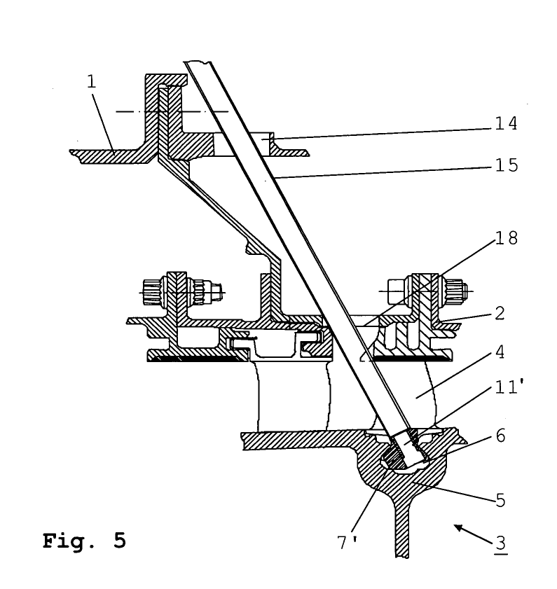

In another embodiment as shown in FIG. 5, the inserts 7′ have a hole 11′ that is in line with an existing slanted air bleeding slot 18 in the inner case 2. In a certain position of the rotor 3, the hole 11′ is in line with the offset air bleeding slot 18 and the even farther offset second opening 14 in the outer case 1. In this case the first opening 13 in the inner case mentioned above is dispensable. The guide tube 15 is guided at an angle and in line with the slanted hole 11′ through the outer case 1 and the inner case 2 and placed onto the insert 7′ for inserting the balancing screw 16 and screwing it into its position in the female threaded section of the hole 11′ of the insert 7′ using the tool 17.

After the balancing screw 16 has been screwed into place, the tool 17 and the guide tube 15 are removed and the first and second openings in the inner and outer case are sealed with a twin plug 19 that is shown in FIG. 2 and screwed to the outer case 1.

The embodiments described above allow balancing of imbalances or residual imbalances after final assembly or repairs while the engine remains assembled. The balancing is performed—at an optimum in terms of rotor dynamics—in a distant diameter section of the rotor disk 5, so that the weight to be added for balancing is kept low. The inserts 7, 7′ can be positioned at a predefined regular spacing between two rotor blades 4 in the existing circumferential grooves 6 of rotor disks 5 of the compressor or turbine with little effort and added weight.

### LIST OF REFERENCE SYMBOLS

1 Outer case
2 Inner case
3 Rotor
4 Rotor blade
5 Rotor disk
6 Circumferential groove
7, 7′ Insert
8 Base part of 7, 7′
9 Threaded part of 7, 7′
10 Platform of 4
11, 11′ Hole of 7
12a Female threaded section of 11, 11′
12b Expanded diameter range of 11, 11′
13 First opening in 2
14 Second opening in 1
15 Guide tube
16 Balancing screw
17 Tool
18 Air bleeding slot
19 Twin plug

What is claimed is:

1. An arrangement for precision balancing the rotor of a gas turbine engine that in fully assembled condition is encompassed by an outer case and an inner case, wherein inserts are inserted at an even spacing into a circumferential groove provided for installing rotor blades of at least one of a plurality of rotor disks of a compressor/turbine of the engine and fixed between adjacent platforms of the rotor blades, said inserts having a hole that comprises a female threaded section for receiving a balancing screw, the respective hole being in line with a first opening in the inner case and a second opening in the outer case at a certain rotational position of the rotor, and a guide tube that is temporarily installable for guiding a tool through the first and second openings and up to the hole.

2. The arrangement according to claim 1, wherein the first and second openings are positioned vertically on top of each other and in line with one of the holes, and the openings can be sealed after balancing with a twin plug.

3. The arrangement according to claim 1, wherein the hole is positioned at an acute angle to the axial direction and in line with an offset air bleeding slot as a first opening in the inner case and further including an even farther offset second opening in the outer case, wherein the second opening is sealable with a single plug.

4. The arrangement according to claim 1, wherein the insert comprises a base part that matches a cross-sectional shape of the circumferential groove and a threaded part encompassed by recesses in adjacent platforms.

5. The arrangement according to claim 1, wherein the hole in the insert comprises a female threaded section.

6. The arrangement according to claim 5, wherein the insert comprises a base part that matches a cross-sectional shape of the circumferential groove and a threaded part encompassed by recesses in adjacent platforms.

7. The arrangement according to claim 2, wherein the insert comprises a base part that matches a cross-sectional shape of the circumferential groove and a threaded part encompassed by recesses in adjacent platforms.

8. The arrangement according to claim 3, wherein the insert comprises a base part that matches a cross-sectional shape of the circumferential groove and a threaded part encompassed by recesses in adjacent platforms.

9. A method for precision balancing the rotor of a gas turbine engine that in fully assembled condition is encompassed by an outer case and an inner case, comprising:
providing inserts at an even spacing into a circumferential groove provided for installing rotor blades of at least one of a plurality of rotor disks of a compressor/turbine of the engine and fixed between adjacent platforms of the rotor blades, said inserts having a hole that comprises a female threaded section for receiving a balancing screw;
aligning the respective hole with a first opening in the inner case and a second opening in the outer case at a certain rotational position of the rotor;
installing a guide tube through the first and second openings and up to the hole for guiding a tool to the threaded hole;
utilizing the tool to install a balancing screw through the guide tube and into a respective hole where additional weight is needed to balance the rotor.

10. The method according to claim 9, wherein the first and second openings are radially aligned with one another and one of the holes, and the openings are sealed after balancing by inserting a twin plug into the first and second openings.

11. The method according to claim 9, wherein the hole is positioned at an acute angle to the axial direction and in line with an offset air bleeding slot as a first opening in the inner case and further providing an even farther offset second opening in the outer case, wherein the second opening is sealed after balancing by inserting a single plug into the second opening.

12. The method according to claim 9, wherein the provided insert includes a threaded part and a base part that has been matched to a cross-sectional shape of the circumferential groove, and is positioned to be encompassed by recesses in adjacent platforms.

13. The method according to claim 9, wherein the hole in the insert is provided with a female threaded section.
